(19) United States
(12) Patent Application Publication
(10) Pub. No.: US 2011/0228210 A1
(43) Pub. Date: Sep. 22, 2011

(54) Compact Foldable Reading Eyeglasses and Lighting System

(76) Inventor: Larry Willett, Scottsdale, AZ (US)

(21) Appl. No.: 12/728,089

(22) Filed: Mar. 19, 2010

(51) Int. Cl. G02C 5/08

(52) U.S. Cl. 351/63

(57) ABSTRACT

A pair of compact foldable reading eyeglasses comprises a frame front including a hinged bridge, the hinged bridge allowing the frame front to upwardly fold such that respective top portions of the frame front are positioned adjacently; and a pair of temple pieces, each one of the pair attached to a respective corner hinge of the frame front and including a first segment and a second segment, the first segment and the second segment attached by a hinge, allowing the respective temple piece to inwardly fold. Preferably, the pair of compact foldable reading eyeglasses looks like standard reading glasses when worn. Preferably, the compact foldable reading eyeglasses are full-framed, and include spring hinges and standard size nose pads and bridges. Preferably, the pair of compact eyeglasses comes with a storage container having an attached light source. Preferably, the storage container is a zippered storage container and the light source is a battery-operated LED. Thus, a user of these eyeglasses not only benefits from having a pair of highly compact reading eyeglasses at his or her disposal, but also can use the small flashlight to read in a dimly lit environment.

### FIELD OF THE INVENTION

The present invention relates to compact foldable reading eyeglasses and a lighting system to facilitate reading in a dimly lit environment.

### BACKGROUND

As a person ages, the ability to focus on near objects progressively diminishes. Once middle age is reached, many people lose significant ability to read books, magazines, menus, etc., without corrective lenses.

Although reading glasses can be purchased to alleviate this problem, they tend to be inconvenient to carry. While various foldable reading eyeglasses have been developed that take up less space, they tend to be uncomfortable to wear. This is because many such eyeglasses do not use standard size eyewear components. Thus, many foldable reading glasses have narrow bridges and small nose pads that pinch the wearer's nose. Furthermore, conventional foldable reading glasses usually fold in such a way that is not optimally compact and/or which tends to allow the lenses to be scratched.

An additional problem for many people is that even if they do have reading glasses available, there often is insufficient lighting. For example, to provide a certain ambience, many restaurants use dim lighting, But this can make it difficult to read the menu. Similar problems exist when attempting to read in a darkened concert hall or a movie theater.

Accordingly, a solution to the above problems would be highly desirable and make a positive difference in the lives of a large segment of the population.

### SUMMARY OF THE INVENTION

A pair of compact foldable reading eyeglasses comprises a frame front including a hinged bridge, the hinged bridge allowing the frame front to upwardly fold such that respective top portions of the frame front are positioned adjacently; and a pair of temple pieces, each one of the pair attached to a respective corner hinge of the frame front and including a first segment and a second segment, the first segment and the second segment attached by a hinge, allowing the respective temple piece to inwardly fold.

Preferably, the pair of compact foldable reading eyeglasses look like standard reading glasses when worn. Preferably, the compact foldable reading eyeglasses are full-framed, and include spring hinges and standard size nose pads and bridges.

Preferably, the pair of compact eyeglasses comes with a storage container having an attached light source. Preferably, the storage container is a zippered storage container and the light source is a battery-operated LED. Thus, a user of these eyeglasses not only benefits from having a pair of highly compact reading eyeglasses at his or her disposal, but also can use the small flashlight to read in a dimly lit environment.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 shows an exemplary pair of compact foldable reading eyeglasses in a folded position;

FIG. 2 shows the front face of the pair of compact foldable reading eyeglasses in a partly open position;

FIG. 3 shows the pair of compact foldable reading eyeglasses with the front face in a fully open position;

FIG. 4 shows a top view of the pair of compact foldable reading eyeglasses of FIG. 3;

FIG. 5 shows the pair of compact foldable reading eyeglasses in an open position;

FIG. 6 shows an LED flashlight attachable to a storage container;

FIG. 7 shows an exemplary zippered storage container for use to store the pair of compact foldable reading eyeglasses; and

FIG. 8 shows a combination including the pair of compact foldable reading eyeglasses, the LED flashlight attachable to the exemplary storage container, and the zippered storage container for use to store the exemplary pair of compact foldable reading eyeglasses.

### DETAILED DESCRIPTION

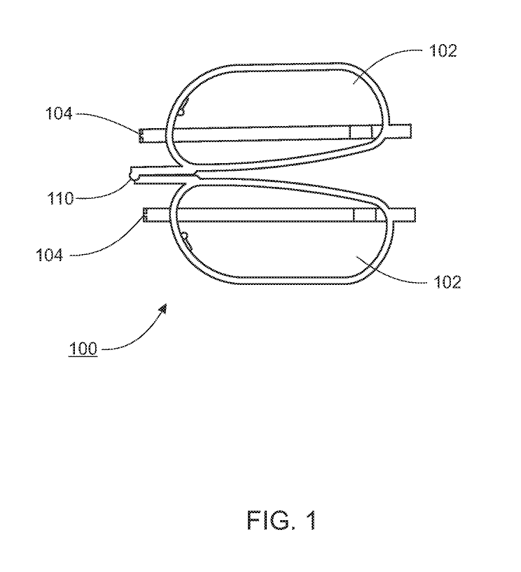

FIG. 1 illustrates an exemplary pair of compact foldable reading eyeglasses 100 in a folded position. When in this folded position, the eyeglasses 100 are compact enough to fit within an area measuring 70*45*5 mm. (i.e., the size of a standard business card). Accordingly, the eyeglasses 100 can be conveniently carried in a purse or a pocket, for example.

As will be described in greater detail, the pair of compact foldable reading eyeglasses 100 preferably comes with a storage container having an attached light source. Preferably, the storage container is a zippered storage container and the light source is a battery-operated LED. Thus, a user of these compact foldable reading eyeglasses 100 not only benefits from having a pair of highly compact reading eyeglasses at his or her disposal, but also can use the small flashlight to read in a dimly lit environment.

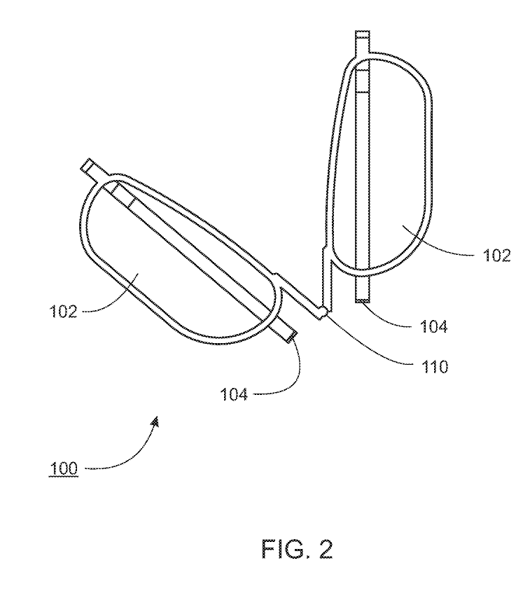

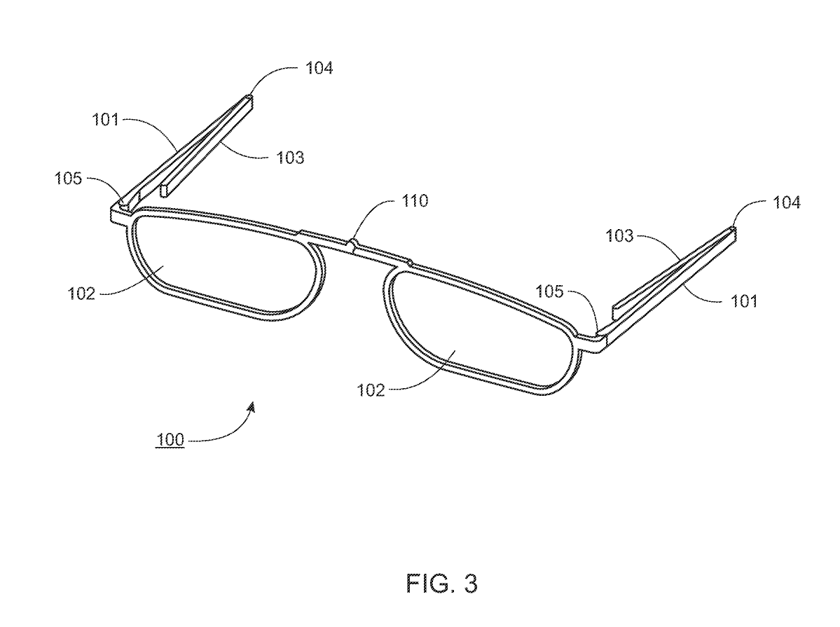

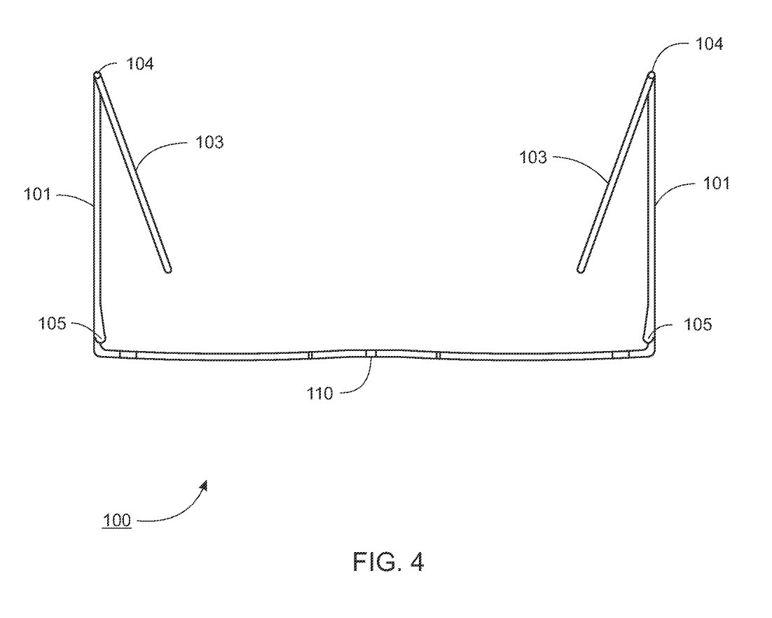

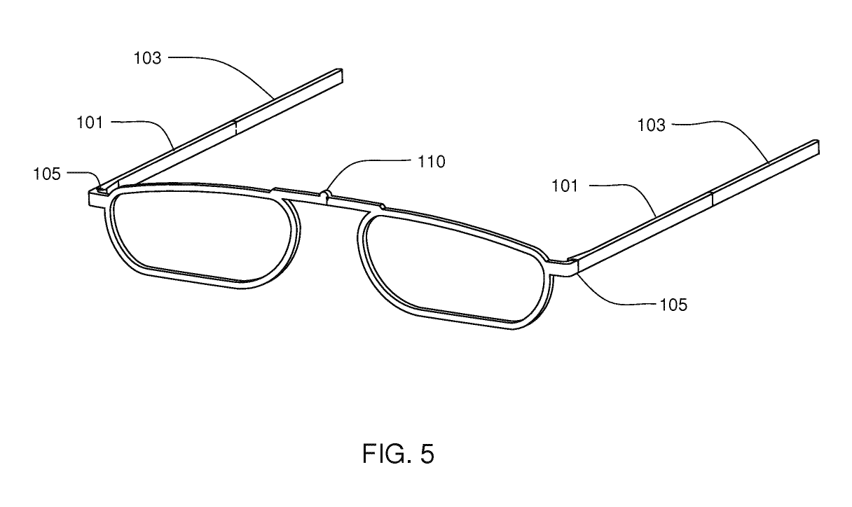

FIG. 2 shows the pair of compact foldable reading eyeglasses 100 in a partly open position. FIG. 3 shows the pair of compact foldable reading eyeglasses 100 in an open position except that the temple pieces are still folded. (FIG. 4 shows a top view of the eyeglasses illustrated in FIG. 3.) FIG. 5 illustrates the pair of compact foldable reading eyeglasses 100 in a fully open position.

As depicted, the pair of compact eyeglasses 100 includes a frame front 102 including a hinged bridge 110. The hinged bridge 110 allows the frame front 102 to upwardly fold such that respective top portions of the frame front 102 are positioned adjacently. Additionally, as shown, the compact foldable reading eyeglasses 100 includes a pair of temple pieces, each one of the pair attached to a respective corner hinge 105 of the frame front 102 and including a first segment 101 and a second segment 103, the first segment 101 and the segment 103 attached by a hinge 104, allowing the respective temple pieces to inwardly fold. Preferably, each corner hinge 105 is a spring hinge to firmly keep the eyeglasses in place while being worn and to provide comfort.

Preferably, the pair of compact foldable reading eyeglasses 100 includes standard size eyewear components. For example, the frames front 102 can be approximately 13 cm. wide and the temples can be approximately 13.5 cm. long.

Preferably, the pair of compact foldable reading eyeglasses 100 can be made to have a particular magnification (diopeter strength). Preferably, magnification strengths will be a predetermined value, e.g., 150%, 200%, 250%, 300%, etc. Preferably, the compact foldable reading eyeglasses 100 will have an indication as to the magnification (or diopeter) strength somewhere on the frames or lenses. However, the compact foldable reading eyeglasses 100 can also include lenses made according to a prescription.

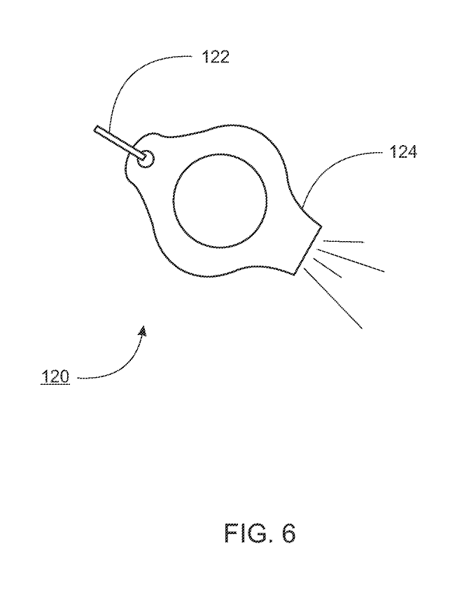

FIG. 6 shows an LED flashlight 120 attachable to the case 100. Preferably, the LED flashlight 120 is battery-operated and includes a housing 124 for encasing both an LED bulb and a battery. Preferably, the housing 124 includes an attachment piece 122 for attaching the LED flashlight 120 to a storage container 125.

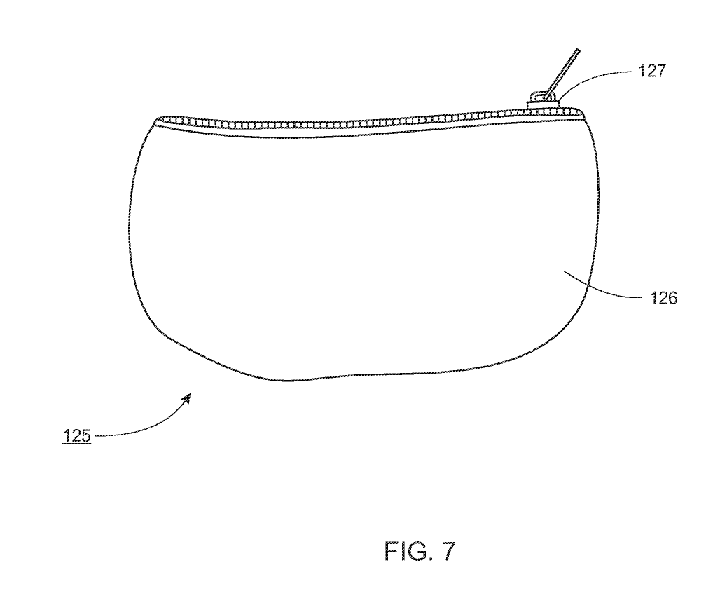

FIG. 7 shows an exemplary zippered storage container 125 useable to store the pair of compact foldable reading eyeglasses 100. Preferably, the storage container includes a zipper 127 and a cover 126 constructed of faux leather. However, other suitable materials may be used for the cover 126, such as, for example, genuine leather, cloth, rubber, plastic, etc. In general, the material chosen for the cover 126 should be durable and provide sufficient cushioning. Furthermore, it is be appreciated that instead of the zipper 127, another way to securely close the storage container 125 may be used, such as, for example, using buttons, Velcro, etc.

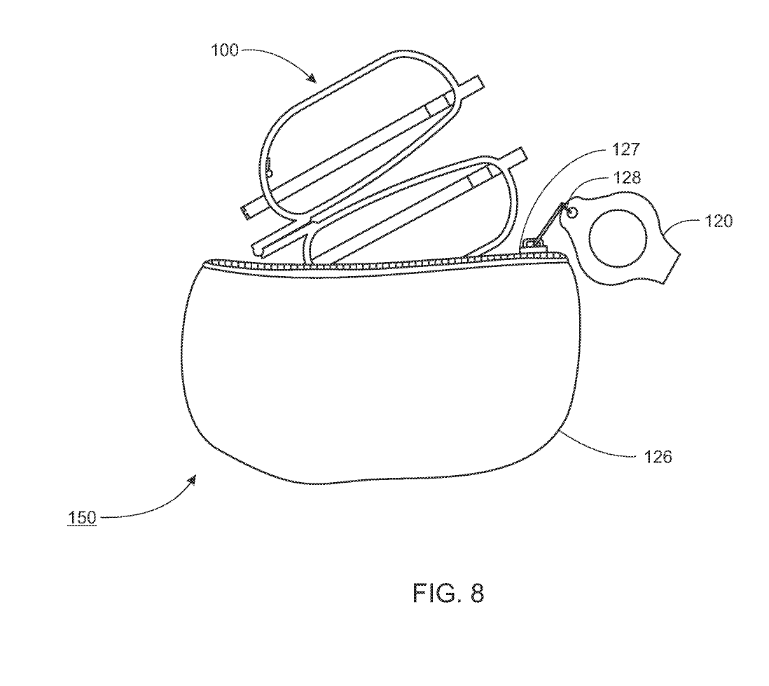

FIG. 8 shows a combination including the pair of compact foldable reading eyeglasses 100, the zippered storage container 125 for use to store the pair of compact foldable reading eyeglasses 100, and the LED flashlight 120 to facilitate reading in a dimly lit environment.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A pair of compact eyeglasses, comprising:
a frame front including a hinged bridge, the hinged bridge allowing the frame front to upwardly fold such that respective top portions of the frame front are positioned adjacently; and
a pair of temple pieces, each one of the pair attached to a respective corner hinge of the frame front and including a first segment and a second segment, the first segment and the second segment attached by a hinge, allowing the respective temple piece to inwardly fold.

2. The pair of compact eyeglasses of claim 1, wherein when folded, the pair of compact eyeglasses can fit within an area measuring 3.5 inches by 2 inches.

3. The pair of compact eyeglasses of claim 1, wherein the frame front is a full frame.

4. The pair of compact eyeglasses of claim 1, wherein the frame front includes a pair of standard nose pads.

5. The pair of compact eyeglasses of claim 1, wherein the corner hinges attaching the temple pieces to the frame front are spring hinges.

6. The pair of compact eyeglasses of claim 1, wherein the eyeglasses are reading eyeglasses having a predetermined diopeter strength.

7. A pair of foldable eyeglasses, comprising:
(a) a frame front including:
(i) a first lens retaining portion retaining a first lens of a pair of lenses,
(ii) a second lens retaining portion retaining a second lens of the pair of lenses, and
(iii) a hinged bridge, the hinged bridge connecting the first lens retaining portion and the second lens retaining portion and allowing the frame front to upwardly fold; and
(b) a pair of temple pieces, including:
(i) a first temple piece having an end attached to a side of the frame front and another end attachable to an ear of an eyeglass wearer; and
(ii) a second temple piece having an end attached to another side of the frame front and another end attachable to another ear of the eyeglass wearer, wherein
each of the temple pieces is inwardly foldable.

8. The pair of foldable eyeglasses of claim 7, wherein the frame front is a full-frame eyeglass frame.

9. The pair of foldable eyeglasses of claim 7, wherein the eyeglasses are reading eyeglasses having a predetermined diopeter strength.

10. The pair of foldable eyeglasses of claim 7, wherein the hinged bridge includes a pin hinge.

11. The pair of foldable eyeglasses of claim 10, wherein a pin of the pin hinge extends inwardly toward the eyeglass wearer when the eyeglasses are worn.

12. The pair of foldable eyeglasses of claim 7, wherein each of the lens retaining portions includes a respective nose pad.

13. The pair of foldable eyeglasses of claim 7, wherein each temple piece is attached to the respective lens retaining portion by a spring hinge.

14. The pair of foldable eyeglasses of claim 7, wherein when folded, the pair of foldable eyeglasses can fit within an area measuring 3.5 inches by 2 inches.

15. A portable reading system, comprising:
the pair of foldable eyeglasses, as defined in claim 7; and
a storage container capable of storing the pair of foldable eyeglasses.

16. The portable reading system of claim 15, wherein the storage container is a zippered storage container.

17. The portable reading system of claim 15, wherein the storage container includes an attached light source.

18. The portable reading system of claim 17, wherein the light source is a battery-operated flashlight.

19. The portable reading system of claim 18, wherein the battery-operated flashlight is a battery-operated LED.

20. The portable reading system of claim 15, wherein the storage container is a zippered faux leather storage container.
